(19) United States
(12) Patent Application Publication
(10) Pub. No.: US 2024/0320733 A1
(43) Pub. Date: Sep. 26, 2024

(54) SYSTEMS AND METHODS FOR FACILITATING BANKING ACTIVITIES VIA AN ANONYMOUS DIGITAL PROFILE

(71) Applicant: Wells Fargo Bank, N.A., San Francisco, CA (US)

(72) Inventors: Tanisha Patterson-Powe, Huntersville, NC (US); Matthew Degenhardt, Charlotte, NC (US); Kourtney Eidam, Marietta, GA (US); Lynne Sanders, Charlotte, NC (US); Anjali Shah, Huntersville, NC (US); Debashis Ghosh, Charlotte, NC (US); Cecil B. Burrowes, Charlotte, NC (US); Nadia Van De Walle, Washington, DC (US); Carrie Anne Hanson, Charlotte, NC (US)

(21) Appl. No.: 18/188,283

(22) Filed: Mar. 22, 2023

(51) Int. Cl. G06Q 40/02; G06F 21/32; G06Q 20/10

(52) U.S. Cl. CPC G06Q 40/02; G06F 21/32; G06Q 20/1085

(57) ABSTRACT

Systems, apparatuses, methods, and computer program products are disclosed for facilitating banking activities via an anonymous digital profile. An example method receiving, by communications hardware, a secured activity request comprising a first identifying metric of an individual and a requested banking activity identifier. The example method also includes determining, by data analysis circuitry, that the individual is not a banked customer. The example method also includes generating, by profile generation circuitry, a digital profile based on the first identifying metric, wherein generating the digital profile does not create a banked relationship with the individual, and wherein the digital profile defines a predefined set of banking activities for which the individual is authorized to perform.

### BACKGROUND

Despite the widespread use of traditional banking services, there remains a significant portion of the population who are “unbanked” and do not use these services. For example, many unbanked individuals lack trust in banks due to a variety of factors. At the same time, however, these individuals stand to benefit from participating in the financial system and accessing banking services such as secure storage of funds, bill payments, and access to credit.

### BRIEF SUMMARY

Many individuals are unbanked for a variety of reasons, such as lack of convenient access to financial institutions, fear of fees, distrust in the banking system to keep their information secure, a lack of identification documents, and/or other factors. However, by joining a bank or similar financial institution, these individuals can realize significant benefits such as access to loans and other financial services, improved security for their money, and the ability to save and manage their finances more effectively. Additionally, having a bank account can improve an individual's financial literacy and credit history, opening up opportunities for better financial stability and growth in the future.

Unbanked individuals may feel overwhelmed when attempting to start a relationship with a bank. For example, a lack of familiarity with banking procedures and terminology may lead to confusion and uncertainty about services being offered. In some cases, historic data breaches and/or the like may make individuals hesitant to provide personally identifiable information (PII) to the bank. The lack of trust towards the banking sector that some unbanked people may have can cause further uncertainty and intimidation. The requirements, fees, and paperwork involved in starting a relationship with a bank can be daunting as well, especially given a limited experience in banking.

At the same time, balancing the need for personal information to comply with Know Your Customer (KYC) regulations and the privacy concerns of unbanked individuals can be a significant challenge for financial institutions. Finding a solution that addresses these conflicting needs is crucial to promoting financial inclusion and increasing access to financial services for unbanked individuals.

Example embodiments described herein set forth a solution to the issues described above by providing systems, apparatuses, and methods for facilitating banking activities via an anonymous digital profile. In various embodiments, an anonymous digital profile identifiable to a single identifying metric may be implemented for an individual that allows the individual to conduct limited banking activities with a financial institution without requiring the individual to hold a traditional account with the bank or disclose PII about themselves to the financial institution. Establishment of the anonymous digital profile may serve as a first step towards the unbanked individual becoming a “banked” customer (e.g., becoming onboarded as a customer of the financial institution and holding an account (e.g., checking, savings, etc.) with the financial institution).

In various embodiments, anonymous digital profiles may be modified over time in response to collecting additional identifying metrics of the individual. The collection of additional identifying metrics may automatically apply new access protocols to the anonymous digital profile which unlock new tiers of banking activities and services previously unavailable to the individual due to the requirement of certain PII.

Some examples of banking services that may be accessed through various tiers include check cashing, account access, loan options, investment opportunities, financial planning services, and/or the like. For example, an individual who provides a low amount of identifying metrics (e.g., one initial identifying metric) may only have access to basic services, such as check cashing, while an individual who provides a higher amount of identifying metrics may have access to more banking activities and services, such as, for example, financial planning services and notarization services. This tiered access system can benefit both the individual and the bank by providing a customized and low-pressure experience for the individual while at the same time enabling the bank to manage risk accordingly.

In various embodiments, identifying metrics may be collected directly from the individual (e.g., at their discretion). In some embodiments, identifying metrics may be inferred based on banking activities performed by the individual. For example, documents (e.g., physical or electronic) exchanged between the individual and the financial institution may be automatically digitally parsed to identify potentially relevant identifying information (e.g., demographic information, certain PII, etc.) about the individual. In this manner, example embodiments may leverage inferred identifying metrics to provide a more efficient onboarding of the individual in an instance in which the individual decides to become a banked customer and formally open an account with the financial institution. For instance, required forms (e.g., for opening an account, enrolling in a banking services program, etc.) may be pre-populated within PII about the individual without the individual having directly provided the PII to the financial institution. In some embodiments, any inferred identifying metrics may be stored securely and only accessed in response to certain requests from the individual.

Accordingly, the present disclosure sets forth systems, methods, and apparatuses that bridge the gap between identity disclosure requirements of financial institutions and privacy needs of the unbanked population by facilitating banking activities via an anonymous digital profile. There are many advantages of these embodiments and other embodiments described herein. For instance, example embodiments greatly simplify the process of becoming a banked customer, thus making it easier for individuals to access financial services. In addition, example embodiments provide a high level of identity security for an unbanked individual. Further, example embodiments allow for pre-population of forms and other required items based on inferred identifying metrics, thereby reducing the time and effort required to complete these items. This results in a more efficient and streamlined process for both the individual and the bank, as well as improved security for the individual's personal information.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for facilitating banking activities via an anonymous digital profile.

FIG. 2A illustrates a schematic block diagram of example circuitry embodying a system device of a banking activity management system that may perform various operations in accordance with some example embodiments described herein.

FIG. 2B illustrates a schematic block diagram of example circuitry embodying a remote device and/or client device that may perform various operations in accordance with some example embodiments described herein.

FIG. 3 illustrates an example flowchart for managing an anonymous digital profile using received identifying metrics, in accordance with some example embodiments described herein.

FIG. 4 illustrates an example flowchart for authorizing performance of a banking activity based on an anonymous digital profile, in accordance with some example embodiments described herein.

FIG. 5 illustrates an example flowchart for inferring identity metrics based on digital records, in accordance with some example embodiments described herein.

FIG. 6 illustrates an example flowchart for determining an offering for an individual based on identifying metrics, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “identifying metric” refers to any metric by which an individual can be identified, either directly or indirectly. An identifying metric may include biometric information (e.g., a fingerprint, iris, palm scan, etc.). An identifying metric may include PII, such as a first name, last name, address, social security number, race, gender, place of employment, and/or the like. In some embodiments, identifying metrics may be provided directly from an individual (e.g., via a client device and over a network). In some embodiments, an identifying metric may comprise a code or other unique identifier based on a device associated with an individual. In some embodiments, identity metrics may be inferred based on banking activities performed by an individual. In this regard, the term “inferred identifying metrics” refers to identifying metrics about an individual which are likely to be correct but are not yet confirmed to be correct through verification by the individual and/or a financial institution. For example, if the individual utilizes a financial institution to cash a check from a business every two weeks for an extended period of time, it may be inferred that the individual is employed by the business. However, the business as their place of employment may still be considered an inferred identifying metric and unverified until the individual (if they so wish) presents proof of employment to the financial institution.

The term “banking activity” refers to an activity which involves an individual and a financial institution (e.g., a bank). An individual may perform a banking activity or request that the banking activity be performed for the individual by the financial institution. A banking activity may involve an individual interacting with a device associated with the financial institution (e.g., an Automated Teller Machine (ATM), kiosk, and/or other devices) and/or personnel associated with the financial institution (e.g., a bank teller, financial consultant, and/or the like). Some examples of banking activities may include, but are not limited to, cashing checks, using an ATM, exchanging foreign currency, global remittances, depositing money into another's account, purchasing a money order and/or cashier's check, making a wire transfer, participating in bank-sponsored events and/or seminars, using notarization services, renting a safe deposit box, using the bank's internal kiosks to access the internet, applying for a loan, opening an account, receiving information on bank products and services, depositing or withdrawing money, transferring funds, obtaining a loan, paying bills through online or in-person services provided by the financial institution, ordering a payment card, requesting a credit card, setting up direct deposit for payroll, managing investments, purchasing foreign currency, applying for insurance products, obtaining financial advice or planning services, receiving statements and/or account information, reporting lost payment cards, and/or the like.

The term “default biometric marker set” refers to a set of types of biometric markers that individuals conventionally provide for authentication or similar processes. The default biometric marker set consists of fingerprints, iris scans, palm scans, and face scans.

The term “standard biometric marker” refers to a biometric marker that individuals typically provide as proof of identification. Examples of standard biometric markers may include any biometric markers in the default biometric marker set or others that are typically provided.

The term “non-standard biometric marker” refers to a biometric marker that individuals do not typically provide as proof of identification and are not included in the default biometric marker set. Some examples of non-standard biometric markers may include gait analysis, elbow scan, voice recognition, vein pattern, etc. In some embodiments, a non-standard biometric marker, if provided to a first entity, would not be able to be used to ascertain an identity of an individual due to the individual having not previously given the non-standard biometric marker to another entity.

### System Architecture

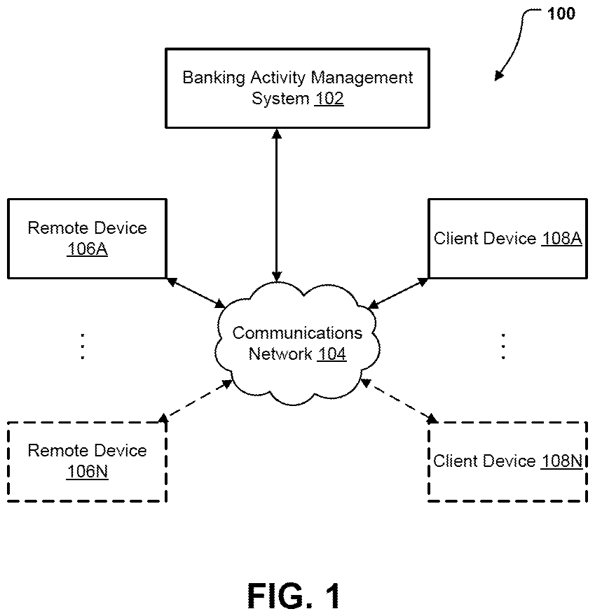

Example embodiments described herein may be implemented using any of a variety of computing devices or servers. To this end, FIG. 1 illustrates an example environment 100 within which various embodiments may operate. As illustrated, a banking activity management system 102 may receive and/or transmit information via communications network 104 (e.g., the Internet) with any number of other devices, such as one or more of remote devices 106A-106N and/or client devices 108A-108N.

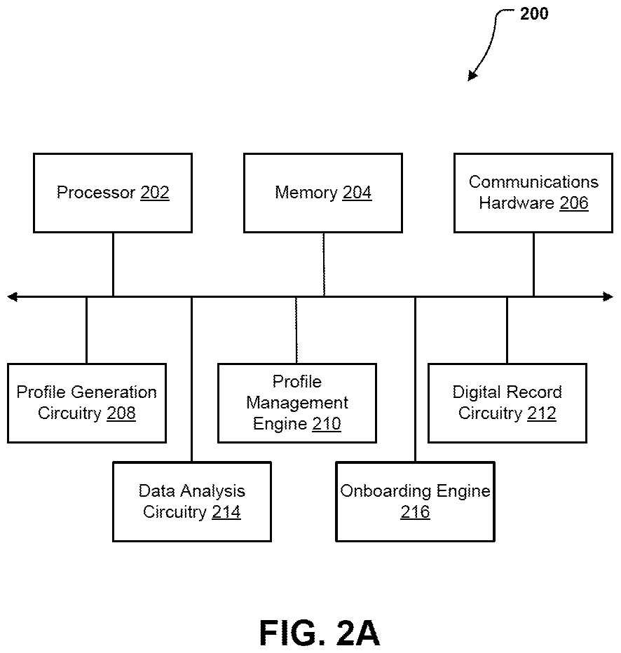

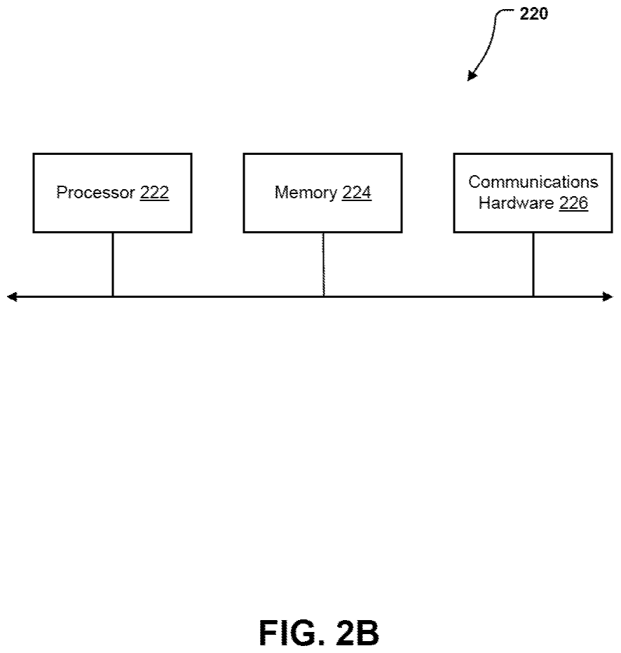

The banking activity management system 102 may be implemented as one or more computing devices or servers, which may be composed of a series of components. In some embodiments, the banking activity management system 102 may be one part of a larger system (e.g., a system managed by a financial institution such as a bank). Particular components of the banking activity management system 102 are described in greater detail below with reference to apparatus 200 in connection with FIG. 2A.

The one or more remote devices 106A-106N and the one or more client devices 108A-108N may be embodied by any computing devices known in the art. The one or more BBB 106A-106N and the one or more BBB 108A-108N need not themselves be independent devices, but may be peripheral devices communicatively coupled to other computing devices.

In some embodiments, the one or more remote devices 106A-106N may comprise devices associated with a financial institution. Some examples include kiosk devices, Automated Teller Machines (ATMs), desktop computers, laptops, cameras, scanners (e.g., body scan devices), and/or the like. In some embodiments, the one or more client devices 108A-108N may comprise personal devices (e.g., mobile phones, smartwatches, laptops, desktop computers, etc.) which may belong to one or more individuals utilizing a financial institution (e.g., unbanked individuals associated with anonymous digital profiles). Individuals may interact, either directly or indirectly, with the banking activity management system 102 via remote devices 106A-106N and/or client devices 108A-108N.

### Example Implementing Apparatuses

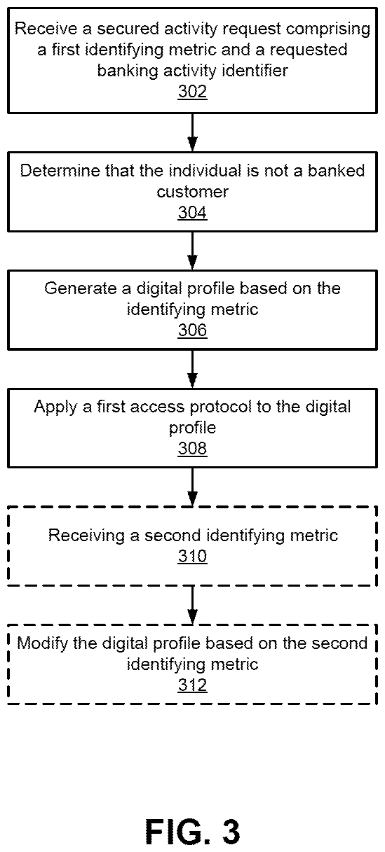

The banking activity management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-6. As illustrated in FIG. 2A, the apparatus 200 may include processor 202, memory 204, communications hardware 206, profile generation circuitry 208, profile management engine 210, digital record circuitry 212, data analysis circuitry 214, and onboarding engine 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises profile generation circuitry 208 that generates a digital profile based on an identifying metric. The profile generation circuitry 208 may utilize processor 202, memory 204, or any other hardware component included in the apparatus 200 to perform these operations, as described in connection with FIG. 3 below. The profile generation circuitry 208 may further utilize communications hardware 206 to gather data (e.g., identifying metric(s)) from a variety of sources (e.g., remote devices 106A-106N and/or client devices 108A-108N), and/or exchange data with a user, and in some embodiments may utilize processor 202 and/or memory 204 to generate a digital profile for an individual based on an identifying metric initially provided by (or for) an individual.

In addition, the apparatus 200 further comprises a profile management engine 210 that applies one or more access protocols to a digital profile and otherwise manages a stored digital profile (e.g., modifies the stored digital profile based on new or updated information). The profile management engine 210 may utilize processor 202, memory 204, or any other hardware component included in the apparatus 200 to perform these operations, as described in connection with FIGS. 3-6 below. The profile management engine 210 may further utilize communications hardware 206 to gather data from a variety of sources (e.g., remote devices 106A-106N and/or client devices 108A-108N, as shown in FIG. 1), and/or exchange data with a user, and in some embodiments may utilize processor 202 and/or memory 204 to store digital records in association with a digital profile, modify identify fields of a digital profile, determine whether criteria for a digital profile is satisfied for certain offerings, and/or apply access protocols to digital profiles.

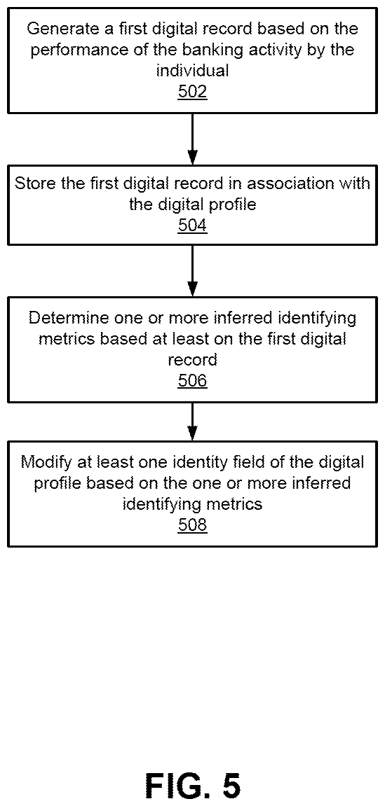

In addition, the apparatus 200 further comprises digital record circuitry 212 that generates digital records based on banking activities performed by individuals. The digital record circuitry 212 may utilize processor 202, memory 204, or any other hardware component included in the apparatus 200 to perform these operations, as described in connection with FIG. 5 below. The digital record circuitry 212 may further utilize communications hardware 206 to gather data from a variety of sources (e.g., remote data sources 106A-106N and/or client devices 108A-108N, as shown in FIG. 1), and/or exchange data with a user, and in some embodiments may utilize processor 202 and/or memory 204 to generate a digital record based on a performance of a banking activity by an individual.

In addition, the apparatus 200 further comprises data analysis circuitry 214 that determines whether an individual is a banked customer based on identifying metrics, verifies submitted identifying metrics, verifies requested banking activity identifiers, and determines inferred identifying metrics based on digital records. The data analysis circuitry 214 may utilize processor 202, memory 204, or any other hardware component included in the apparatus 200 to perform these operations, as described in connection with FIG. 5 below. The data analysis circuitry 214 may further utilize communications hardware 206 to gather data from a variety of sources (e.g., profile management engine 210 remote data sources 106A-106N and/or client devices 108A-108N, as shown in FIG. 1), and/or exchange data with a user, and in some embodiments may utilize processor 202 and/or memory 204 to determine whether an individual is a banked customer, verify identifying metrics and/or requested banking activity identifiers, and/or determine inferred identity metrics based on one or more digital records.

In addition, the apparatus 200 further comprises an onboarding engine 216 that generates an account and/or other offerings for an individual based on information contained in identity fields of a digital profile. In this regard, the onboarding engine 216 may generate accounts, electronic forms and/or other documents, and/or the like which serve to “onboard” an individual as a customer of a financial institution. The onboarding engine 216 may utilize processor 202, memory 204, or any other hardware component included in the apparatus 200 to perform these operations, as described in connection with FIG. 5 below. The data analysis circuitry 214 may further utilize communications hardware 206 to gather data from a variety of sources (e.g., profile management engine 210 remote data sources 106A-106N and/or client devices 108A-108N, as shown in FIG. 1), and/or exchange data with a user, and in some embodiments may utilize processor 202 and/or memory 204 to generate a digital record based on a performance of a banking activity by an individual.

Although components 202-216 are described in part using functional language, it will be understood that the particular implementations necessarily include the use of particular hardware. It should also be understood that certain of these components 202-216 may include similar or common hardware. For example, the profile generation circuitry 208, profile management engine 210, digital record circuitry 212, data analysis circuitry 214, and onboarding engine 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the profile generation circuitry 208, profile management engine 210, digital record circuitry 212, data analysis circuitry 214, and onboarding engine 216 may leverage processor 202, memory 204, or communications hardware 206 as described above, it will be understood that any of profile generation circuitry 208, profile management engine 210, digital record circuitry 212, data analysis circuitry 214, and onboarding engine 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that profile generation circuitry 208, profile management engine 210, digital record circuitry 212, data analysis circuitry 214, and onboarding engine 216 comprise particular machinery designed for performing the functions described herein in connection with such elements of apparatus 200.

As illustrated in FIG. 2B, an apparatus 220 is shown that represents an example remote device (e.g., any of remote devices 106A-106N) or an example client device (e.g., any of client devices 108A-108N). The apparatus 220 includes processor 222, memory 224, and communications hardware 226, each of which is configured to be similar to the similarly named components described above in connection with FIG. 2A.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by system device of the banking activity management system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, profile generation circuitry 208, profile management engine 210, digital record circuitry 212, data analysis circuitry 214, and onboarding engine 216, and/or any combination thereof. It will be understood that user interaction with the banking activity management system 102 may occur directly via communications hardware 206, or may instead be facilitated by a separate client device 108A-108N or remote device 106A-106N, as shown in FIG. 1, and which may have similar or equivalent physical componentry facilitating such user interaction.

Turning first to FIG. 3, example operations are shown for managing an anonymous digital profile using received identifying metrics.

As noted above, financial institutions have a need to attract unbanked individuals in order to serve their financial needs and provide them with access to financial products and services. However, unbanked individuals often have concerns about privacy and security when it comes to interacting with banks. As a first step, example embodiments herein provide a means for an individual to begin utilizing certain services offered by a bank while still remaining anonymous to the bank in that they are not required to directly provide any PII which would reveal their identity. In this regard, an anonymous digital profile may be generated for an unbanked individual that is tied to an initial identifying metric for the individual. As shown by operation 302, the apparatus 200 includes means, such as processor 202, memory 204, communications hardware 206, and/or the like, for receiving a secured activity request comprising a first identifying metric of an individual and a requested banking activity identifier.

In some example embodiments, an individual may approach a bank (e.g., via a bank teller, or a device such as an ATM) and express interest in conducting certain banking activities through the bank but not actually becoming a member of the bank. For example, the individual may want to be able to cash their paycheck at the bank without opening an account with the bank or establishing a formal banking relationship. In this regard, in some embodiments, the individual may be presented with the option to begin an anonymous digital profile with the bank. In order to do so, the individual may provide an initial identifying metric, which can be subsequently provided each time they wish to perform a banking activity involving the financial institution.

In some embodiments, the secured activity request may be secured in that the contents of the secured activity request are not exposed to anyone before being received by the banking activity management system 102. For example, if an unbanked individual were to approach a bank teller and request to cash a check without stating that they are in fact not a banked customer, the teller would remain unaware that the individual is unbanked. In this regard, a secured activity request may be generated (e.g., by the teller, or in some embodiments, automatically by a device such as an ATM) which includes a first identifying metric of the individual (e.g., the individual could provide a biometric marker via a scanning device) as well as a requested banking activity identifier. For instance, the individual could specify a requested banking activity (e.g., cashing a check) which can be digitally represented by the requested banking activity identifier (e.g., as an alphanumeric code or the like). In some embodiments, generation of the secured activity request may be performed by a device (e.g., an ATM) as the individual is utilizing the device. In this manner, the individual may provide their first identifying metric and select or otherwise indicate a requested banking activity at the device (e.g., via a user interface displayed by an ATM). The device may then transmit a secured activity request to the banking activity management system 102 for further processing.

In some embodiments, the initial identifying metric may be a biometric marker, such as a fingerprint, palm scan, iris scan, or other type of biometric marker. In some embodiments, the biometric marker may be a non-standard biometric marker, such as an elbow scan, voice input (e.g., for voice recognition), gait analysis (e.g., as processed by one or more cameras, body scan devices, and/or the like in the vicinity of the individual), and/or other non-standard biometric markers. While the biometric marker represents the individual, it does not readily identify who they actually are; rather, the biometric marker lets the financial institution know when banking activities are performed by the individual and which banking activities are therefore associated with the individual (e.g., by having the individual provide the initial identifying metric each time they would like to perform a banking activity).

In some embodiments, to provide a higher level of data protection for the individual, the individual may provide an initial identifying metric by way of their personal device (e.g., a mobile phone, smartwatch, etc.) rather than providing initial identifying metric directly to the financial institution (e.g., via a bank teller or ATM), the biometric can be provided by way of the individual's personal device (e.g., a client device 108A-108N), such that the financial institution does not receive the biometric, but rather receives a unique identifier generated by a device operator associated with the device (e.g., a phone manufacturer), along with an acknowledgement of receipt of the initial identifying metric. In this regard, the individual's device can “vouch” for their identity to the financial institution without revealing their actual identity. In some examples, this may be performed through authentication methods at the individual's personal device, such as biometric authentication, secure token-based authentication, and/or the like. In this manner, the individual's personal device acts as a secure device that provides an identity confirmation indication to the financial institution without sharing any PII. This may be beneficial in cases where the unbanked individual has a strong distrust of the banking sector and would prefer not to initially reveal any information directly to a financial institution while still being able to access and test out certain services offered by the financial institution.

In some embodiments, the initial identifying metric may not be provided by the individual, but rather, generated for the individual by the financial institution. For example, the initial identifying metric may be a unique code (e.g., an alphanumeric string or the like) generated by the bank and provided to the individual such that the bank can identify banking activities performed by that individual. In this regard, in some embodiments, the apparatus 200 includes means, such as processor 202, memory 204, profile generation circuitry 208, and/or the like, for generating an initial identifying metric. In some embodiments, an initial identifying metric such as a unique code may be based on an indicator that is associated with a device belonging to or otherwise associated with the individual. For instance, in some embodiments, a unique code may be generated based on a Media Access Control (MAC) address associated with a personal client device belonging to the individual. In some embodiments, for example, the unique code may comprise a one-way hash of the MAC address. In this manner, it can be ensured that the initial identifying metric is unique to the individual (due to MAC addresses being globally unique) while also keeping their MAC address secured (e.g., via the hash).

In some embodiments, a unique code generated as an initial identifying metric may be stored on a chip of a physical card physical card (e.g., a card resembling an identification (ID) card, debit card, etc.) comprising Near Field Communication (NFC) capabilities and issued to the individual by the financial institution. In this regard, the individual may present their card and wirelessly (e.g., via NFC) transmit their unique code to a nearby device to identify themselves as that individual, rather than state the unique code aloud or type the unique code into a terminal. The physical card may only serve as a means for the individual to provide their initial identifying metric when needing to perform a banking activity. However, in some embodiments, the physical card may later be upgraded and linked to a bank account (if opened by the individual).

As shown by operation 304, the apparatus 200 includes means, such as processor 202, memory 204, data analysis circuitry 214, or the like, for determining that the individual is not a banked customer. For example, the banking activity management system 102 may determine whether the individual is a banked customer of the financial institution or not by querying one or more repositories storing previously received identifying metrics and attempting to find a match between a stored identifying metric and the first identifying metric.

As shown by operation 306, the apparatus 200 includes means, such as processor 202, memory 204, profile generation circuitry 208, or the like, for generating a digital profile based on the first identifying metric. The digital profile may comprise a data structure comprising a plurality of identity fields. Identity fields of a digital profile are fields which define certain identifying metrics (e.g., information or characteristics) of the individual. For example, an example digital profile may have an identity field indicating a first name of the individual, an identity field indicating a last name of the individual, an identity field indicating a social security number of the individual, and the like. Upon generation, the digital profile may only contain an association to the initial identifying metric supplied (i.e., the first identifying metric). For instance, the digital profile may be associated with a digital representation of a biometric marker submitted by the individual as their initial identifying metric. As another example, the digital profile may be associated with the unique code generated for the individual (e.g., based on a MAC address of their personal device, as described above). In this regard, most or all identity fields of the digital profile may not contain any information upon generation of the digital profile, as this information has not yet been received or inferred. In this manner, initially generating the digital profile does not create a banked relationship with the individual (as their true identity is still unknown to the financial institution) but, once generated, the digital profile may allow the individual to perform certain banking activities, as further described below.

As shown by operation 308, the apparatus 200 includes means, such as processor 202, memory 204, profile management engine 210, or the like, for applying a first access protocol to the digital profile. In various embodiments, certain access protocols may be applied to a digital profile based on an amount of identifying metrics contained in the digital profile. An access protocol is a data structure that maps to certain digital representations or indications of banking activities that an individual is permitted to perform or take part in, given their level of identity disclosed to (and verified by) the financial institution. For example, the first access protocol may be applied to a digital profile that is only associated with an initial (first) identifying metric and contains no other identifying information about the individual. The first access protocol may only map to select banking activities in which the individual can participate in having only provided the initial identifying metric. These banking activities may be predefined and digitally represented as banking activity identifiers (e.g., alphanumeric codes or the like). Said differently, the first access protocol being applied to the digital profile enables an individual associated with the first identifying metric to perform one or more banking activities from a predefined set of banking activities (i.e., banking activity identifiers) associated with the first access protocol. For example, the first access protocol may only allow the individual to cash checks at the financial institution. In this regard, the individual may be unable to perform or participate in other banking activities (e.g., transferring money, remittance, notarization services) until more identifying metrics are provided by the individual.

By applying access protocols to digital profiles, a financial institution is able to appropriately manage its risk when it comes to unidentified individuals who wish to perform certain activities within the financial institution. Additionally, the individual may feel more comfortable with the financial institution in knowing that they are barred from certain activities due to the fact that they have not disclosed their full identity and the financial institution does not know who they are. This may lead to the individual building trust in the financial institution, which may result in the individual desiring access to more services and being more forthcoming with identifying metrics at a later time.

As shown by operation 310, the apparatus 200 includes means, such as processor 202, memory 204, communications hardware 206, and/or the like, for receiving a second identifying metric. For instance, due to a need to perform a certain banking activity with the financial institution, the individual may optionally provide an additional identifying metric (or multiple identifying metrics) in order to provide enough PII to be able to participate in the banking activity. For instance, to access notarization services, the individual may need to disclose their full name to the financial institution (along with proof, such as a form of identification, birth certificate, and/or the like).

As shown by operation 312, the apparatus 200 includes means, such as processor 202, memory 204, profile management engine 210, or the like, for modifying the digital profile based on the second identifying metric. In some embodiments, modifying the digital profile may comprise supplementing an identity field of the digital profile to include the second identifying metric. For example, an identity field indicating a first name of the individual may be updated to include their actual first name in response to the individual providing their first name to the financial institution. In some embodiments, modifying the digital profile may comprise applying a second access protocol to the digital profile. For example, based on additional PII now contained in the digital profile, additional banking activities may be made available to the individual. In this regard, the second access protocol may map to all banking activities of the first protocol and also map to one or more additional banking activities not made available by the first access protocol.

If the digital profile is updated to include additional identifying metrics provided an individual in addition to their initial identifying metric, the digital profile may no longer actually be “anonymous” in that the financial institution may now have some knowledge of the individual's identity. However, this may be completely left up to the individual to decide whether they wish to remain anonymous (and not provide additional identifying metrics) or begin accessing additional banking activities.

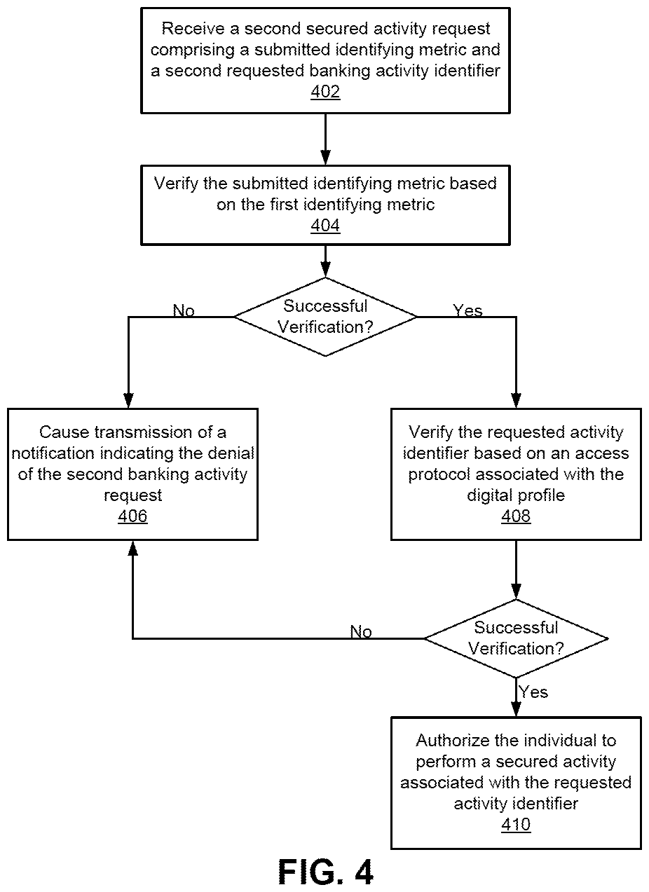

As discussed above, once a digital profile is generated for an individual and the digital profile is associated with at least an initial identifying metric, the individual may begin engaging with the financial institution to perform certain banking activities allowable by the particular access protocol applied to their digital profile. Turning to FIG. 4, example operations are shown for authorizing performance of a banking activity based on a digital profile.

As shown by operation 402, the apparatus 200 includes means, such as processor 202, memory 204, communications hardware 206, and/or the like, for receiving a second secured activity request comprising a submitted identifying metric and a second requested banking activity identifier. In this regard, an individual that is already associated with a digital profile may request to perform a specific banking activity and submit an identifying metric to do so. As noted above, the individual may do so directly via a device, such as an ATM or personal client device, or indirectly (e.g., via a teller and a device associated with the teller). Upon receiving the second secured activity request, the banking activity management system 102 may then verify the submitted biometric and, once verified, verify the requested activity identifier (e.g., verify that the individual is allowed to perform a banking activity indicated by the requested banking activity identifier based on their digital profile).

As shown by operation 404, the apparatus 200 includes means, such as processor 202, memory 204, data analysis circuitry 214, and/or the like, for verifying the submitted identifying metric based on the first identifying metric. In this regard, the data analysis circuitry 214 may compare the submitted identifying metric to stored identifying biometrics previously received by the banking activity management system 102 in order to locate the digital profile for the individual and confirm that any subsequent banking activity that takes place in response to the second secured activity request should be associated with the digital profile. As shown in FIG. 4, if the submitted identifying metric is not able to be verified, the method may continue to operation 406, wherein the apparatus 200 includes means, such as processor 202, memory 204, communications hardware 206, or the like, for causing transmission of a notification indicating the denial of the second banking activity request. For example, the notification can be transmitted to the device from which the second banking activity request was transmitted (e.g., a device which the individual is directly or indirectly interacting with in an attempt to perform a banking activity). In some embodiments, the notification may indicate to the individual to attempt to re-submit their identifying metric (e.g., due to possible mis-entry or a bad reading of a biometric or the like).

In response to a successful verification of the submitted identifying metric, the method may continue to operation 408, wherein the apparatus 200 includes means, such as processor 202, memory 204, data analysis circuitry 214, or the like, for verifying the requested banking activity identifier based on an access protocol associated with the digital profile. In this regard, the data analysis circuitry 214 may confirm that the second requested banking activity identifier is among the predefined banking activity identifiers defined by the access protocol that is applied to the digital profile. In other words, the data analysis circuitry 214 confirms whether the individual is authorized to perform the requested banking activity. If the requested activity identifier is not able to be verified, the method may continue to operation 406, wherein a notification indicating the denial of the second banking activity request is transmitted to a device. In some embodiments, the notification can provide notice to the individual that certain identifying metrics need to be submitted by the individual in order to perform the requested banking activity. For example, in order for the individual to take advantage of notarization services, the individual would have to provide the bank with their first and last name (along with additional proof, such as a driver's license or state identification card).

In response to a successful verification of the requested activity identifier, the method may continue to operation 410, wherein the apparatus 200 includes means, such as processor 202, memory 204, data analysis circuitry 214, or the like, for authorizing the individual to perform a banking activity associated with the second requested banking activity identifier based on the verification of the submitted identifying metric and the second requested banking activity identifier. For instance, the banking activity management system 102 may authorize the individual to perform the banking activity by providing access to certain menus or user interfaces (e.g., via an ATM or other device) for the individual to perform the banking activity. In some embodiments, the authorization may involve transmission of a notification to a teller device indicating to a bank teller that the individual is permitted to perform the banking activity.

In various embodiments, the banking activity management system 102 may generate digital records of banking activities performed by individuals associated with anonymous digital profiles as they are performed. By doing so, several advantages are realized. First, digital records may be accessed and used to identify particular activities performed by the individual, in the case of an error or other issue occurring with one or more banking activities performed by the individual. Additionally, digital records may be processed in order to infer identifying metrics about the individual without the individual having actually directly provided the identifying metrics to the financial institution. By doing so, this may create a more efficient onboarding process for the individual in that electronic forms and/or other documents may be automatically populated with identifying information inferred to likely be correct. In this manner, the individual can simply verify the inferred identity metrics (and may provide additional proof) if they decide to become a banked customer.

Turning to FIG. 5, example operations are shown for inferring identity metrics based on digital records. As shown by operation 502, the apparatus 200 includes means, such as processor 202, memory 204, digital record circuitry 212, or the like, for generating a first digital record based on a performance of a banking activity by the individual. A digital record may be generated based on electronic and/or physical resources (e.g., documents and/or other resources) exchanged between the individual and the financial institution during a banking activity. For example, a banking activity may involve an individual cashing a physical check via an ATM. In some embodiments, the physical check, once received via the ATM, may be processed to generate an electronic representation of the check. In some embodiments, any electronic representations of checks, documents, or other resources involved in the banking activity may be stored as part of the digital record in association with the digital profile. In this regard, as shown by operation 504, the apparatus 200 includes means, such as processor 202, memory 204, profile management engine 210, and/or the like, for storing the first digital record in association with the digital profile.

The digital record may also comprise additional information about the banking activity, such as computational resources that were involved in the banking activity (e.g., Internet Protocol addresses and/or MAC addresses of devices involved), timestamps (e.g., a date and time when the banking activity took place), identifiers for a physical location (e.g., a branch) at which the banking activity took place, location information (e.g., Global Positioning System (GPS) coordinates of devices involved), and/or other information associated with the banking activity.

As shown by operation 506, the apparatus 200 includes means, such as processor 202, memory 204, data analysis circuitry 214, and/or the like, for determining one or more inferred identifying metrics based at least on the first digital record. For example, an electronic representation of a resource used in the banking activity may be digitally parsed to infer potentially relevant identifying metrics. For instance, the check may be made out to the individual themselves, and, by parsing the check, a first and last name of the individual may be inferred. In some embodiments, the data analysis circuitry 214 may utilize various techniques, such as Natural Language Processing techniques in performing the parsing of various resources. For instance, NLP may be used to identify key elements such as a payee name, check amount, date, payer name, etc. In some embodiments, handwriting may be recognized via Optical Character Recognition (OCR) techniques. Once these elements are extracted, they may be mapped to certain identity fields of a digital profile as inferred identifying metrics and, in some embodiments, may be used as supplemental information for a digital record. In this regard, as shown by operation 508, the apparatus 200 includes means, such as processor 202, memory 204, profile management engine 210, and/or the like, for modifying at least one identity field of the digital profile based on the one or more inferred identifying metrics.

In some embodiments, determining inferred identifying metrics in this manner may involve using one or more algorithms and/or rules which determine an appropriate identity field for each piece of information. These algorithms and/or rules may be based on a variety of factors, including the type of document being processed, the context of the information, and/or the like. For example, in the context of a check, specific keywords or patterns may be identified (e.g., the word “payee” or a currency symbol) to determine the appropriate identity field in which to include the information. Similarly, contextual clues, such as the location of information on a check or other document, can be used to determine appropriate identity fields and/or other supplemental information for the digital record (e.g., a date). In some embodiments, rules may be manually defined and/or generated through machine learning (ML) techniques based on sample data.

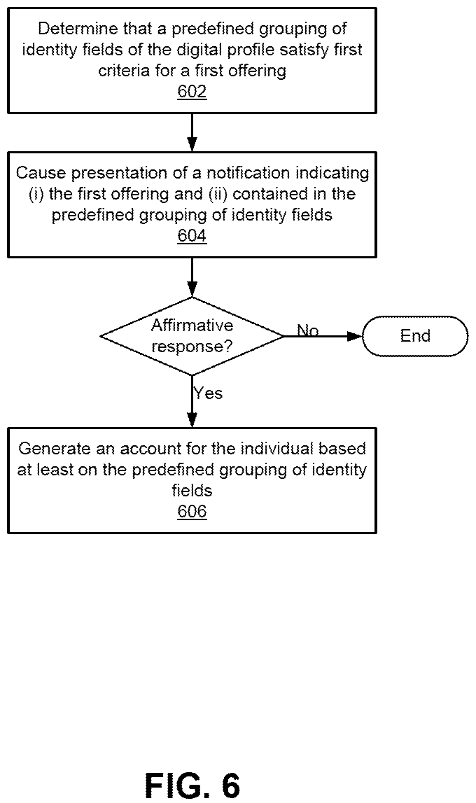

In some embodiments, as identifying metrics are collected over time (e.g., by inferring identifying metrics or obtaining and verifying identifying metrics directly from the individual), the banking activity management system 102 may monitor a digital profile to determine whether the individual associated with the digital profile is eligible to receive an offering from the financial institution based on how many identifying metrics are included in their digital profile. In other words, by having supplied enough identifying information (either directly or indirectly), it can be determined that the individual is eligible for a certain offering (given that the identifying metrics can be verified). In some embodiments, an offering can comprise an offering for a loan, credit card, or similar financial instrument. In some embodiments, an offering may comprise an invitation for the individual to open an account with the financial institution (and thus formally become a banked customer of the financial institution). Turning to FIG. 6, example operations are shown for determining an offering for an individual based on identifying metrics.

As shown by operation 602, the apparatus 200 includes means, such as processor 202, memory 204, profile management engine 210, or the like, for determining that a predefined grouping of identity fields of the digital profile satisfy criteria for a first offering. For example, in some embodiments, the banking activity management system 102 may store a mapping between groups of identity fields and offerings. The profile management engine 210 may identify whether criteria for an offering is satisfied based on certain identity fields of a digital profile containing data (e.g., identifying metrics) by comparing the values of the fields with the criteria. For example, to open an account, certain identity fields would have to contain identifying metrics. This may include first name, last name, social security number, and one or more other identity fields. In some embodiments, if it is determined that these identity fields contain data, it may be determined that criteria for offering an invitation to open an account is satisfied.

As shown by operation 604, the apparatus 200 includes means, such as processor 202, memory 204, communications hardware 206, or the like, for causing presentation of a notification indicating the first offering. For instance, the notification can be transmitted and presented at a device the individual is currently using, such as a device within a branch, a personal client device, an ATM, or the like. In some embodiments, the notification may include an indication of one or more identifying metrics. For instance, the notification may address the individual by their first name (based on an inferred identifying metric) without the individual having directly provided their first name to the financial institution.

As shown in FIG. 6, the individual may respond to the notification by accepting or declining the offering. In the event the individual declines the offering, the method ends, and the notification may be withdrawn. In some embodiments, when the individual accepts the offering (e.g., an affirmative response), the method continues to operation 606, wherein the apparatus 200 includes means, such as processor 202, memory 204, onboarding engine, and/or the like, for generating an account for the individual based at least on the predefined grouping of identity fields. In this regard, the onboarding engine may digitally generate an account (or multiple accounts) for the individual (e.g., a checking account, savings account, etc.) such that the individual becomes a banked customer. In some embodiments, the account may be a temporary account having limited features (e.g., depositing and/or withdrawing funds, but not transferring funds). For instance, an individual at an ATM may be presented with the offering via the ATM and accept the offering to open an account. The individual may then be able to deposit any cash they have on them at the time to the account via the ATM. However, the account may still be considered temporary until the individual can verify certain information about their identity. For instance, the individual may need to provide physical documents (e.g., driver's license, social security card, etc.) in order to remove limitations of the temporary account.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-6 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved interactions between individuals and financial institutions by facilitating banking activities via an anonymous digital profile. Example embodiments thus provide tools that overcome the problems faced by both financial institutions and unbanked individuals when attempting to form a banked relationship. Through an anonymous digital profile, an unbanked individual's barrier to entry with a financial institution may be greatly reduced, while also allowing the financial institution to manage risk accordingly. In this regard, unbanked individuals can experience less hassle and more privacy in performing banking activities than traditional implementations. Moreover, embodiments described herein can leverage an anonymous digital profile to build out an identity for an unbanked individual over time (e.g., through receiving additional identifying metrics from the individual and/or through inferring identifying metrics of the individual based on banking activities performed by the individual). Thus, an anonymous digital profile may evolve over time into a resource that expedites customer onboarding processes for individuals desiring to become banked and hold an account with a financial institution.

Further, example embodiments ensure any identifying metrics (even an initial identifying metric) are kept secure and private through the automatic backend determination of whether the individual is a banked customer and subsequent automatic generation of an anonymous digital profile in connection with the initial identifying metric (e.g., as described above in connection with FIG. 3). In this manner, all identifying metrics as well as the banked status of the individual are kept private (e.g., even to a bank teller who may be facilitating an interaction with the individual at the time). Likewise, in real-time, the individual, by simply providing their initial identifying metric, can be enabled to access certain banking services through their generated anonymous digital profile via any branch or ATM associated with the financial institution. In this regard, the anonymous digital profile can be distributed across a network of bank branches or other locations associated with a financial institution substantially in real-time, thereby allowing the individual to instantaneously have access to certain banking activities at any location they desire.

As these examples all illustrate, example embodiments contemplated herein provide technical solutions that solve real-world problems faced by both (i) financial institutions needing to adhere to KYC requirements and (ii) unbanked individuals lacking trust in the banking sector.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a secured activity request comprising a first identifying metric of an individual and a requested banking activity identifier;
determining, by data analysis circuitry, that the individual is not a banked customer; and
generating, by profile generation circuitry, a digital profile based on the first identifying metric, wherein generating the digital profile does not create a banked relationship with the individual, and wherein the digital profile defines a predefined set of banking activities that the individual is authorized to perform.

2. The method of claim 1, wherein the predefined set of banking activities is based on the first identifying metric.

3. The method of claim 2, further comprising:
applying, by a profile management engine, a first access protocol associated with the predefined set of banking activities to the digital profile, wherein applying the first access protocol to the digital profile enables the individual to perform one or more banking activities from the predefined set of banking activities based on the individual having only provided the first identifying metric.

4. The method of claim 1, further comprising:
receiving, by the communications hardware, a second secured activity request comprising a submitted identifying metric and a second requested banking activity identifier;
verifying, by the data analysis circuitry, the submitted identifying metric based on the first identifying metric; and
in response to a successful verification of the submitted identifying metric:
verifying, by the data analysis circuitry, the second requested banking activity identifier based on the predefined set of banking activities; and
in response to a successful verification of the second requested banking activity identifier, authorizing, by the data analysis circuitry, the individual to perform a banking activity associated with the second requested banking activity identifier.

5. The method of claim 1, further comprising:
generating, by digital record circuitry, a first digital record based on a performance of a banking activity of the predefined set of banking activities by the individual; and
storing, by a profile management engine, the first digital record in association with the digital profile.

6. The method of claim 5, further comprising:
determining, by the data analysis circuitry, one or more inferred identifying metrics based at least on the first digital record; and
modifying, by the profile management engine, at least one identity field of the digital profile based on the one or more inferred identifying metrics, wherein the digital profile comprises a plurality of identity fields related to identifying metrics of the individual.

7. The method of claim 1, further comprising:
determining, by a profile management engine, that a predefined grouping of identity fields of the digital profile satisfies a first criteria for a first offering; and
causing presentation, by the communications hardware, of a notification indicating the first offering.

8. The method of claim 7, wherein the notification is presented at an Automated Teller Machine (ATM).

9. The method of claim 7, wherein the first offering comprises an invitation to open an account for the individual.

10. The method of claim 9, further comprising:
receiving, by the communications hardware, an affirmative response to the notification; and
in response to receiving the affirmative response:
generating, by an onboarding engine, an account for the individual based at least on the predefined grouping of identity fields.

11. The method of claim 1, further comprising:
receiving, by the communications hardware, a second identifying metric associated with the individual; and
modifying, by a profile management engine, the digital profile based on the second identifying metric.

12. The method of claim 11 wherein modifying the digital profile based on the second identifying metric comprises:
applying, by the profile management engine, a second access protocol to the digital profile, wherein applying the second access protocol to the digital profile enables the individual to additionally perform one or more banking activities from a second predefined set of banking activities associated with the second access protocol based on the individual having at least provided the second identifying metric in addition to the first identifying metric.

13. The method of claim 1, wherein at least one banking activity of the predefined set of banking activities involves an interaction between the individual and a device associated with a financial institution.

14. The method of claim 1, wherein the first identifying metric comprises a biometric marker of the individual.

15. The method of claim 14, wherein the biometric marker of the individual is a non-standard biometric marker.

16. The method of claim 1, wherein the first identifying metric comprises a unique identifier based on an indicator of a device associated with the individual.

17. The method of claim 1, wherein the first identifying metric comprises an identity confirmation indication verified by a third-party.

18. The method of claim 1, wherein the first identifying metric is received via a device associated with the individual.

19. An apparatus comprising:
communications hardware configured to receive a secured activity request comprising a first identifying metric of an individual and a requested banking activity identifier;
data analysis circuitry configured to determine that the individual is not a banked customer; and
profile generation circuitry configured to generate a digital profile based on the first identifying metric, wherein generating the digital profile does not create a banked relationship with the individual, and wherein the digital profile defines a predefined set of banking activities that the individual is authorized to perform.

20. A computer program product comprising at least one non-transitory computer-readable storage medium storing software instructions that, when executed, cause an apparatus to:
receive a secured activity request comprising a first identifying metric of an individual and a requested banking activity identifier;
determine that the individual is not a banked customer; and
generate a digital profile based on the first identifying metric, wherein generating the digital profile does not create a banked relationship with the individual, and wherein the digital profile defines a predefined set of banking activities that the individual is authorized to perform.
